(19) United States
(12) Patent Application Publication
(10) Pub. No.: US 2016/0362536 A1
(43) Pub. Date: Dec. 15, 2016

(54) LOW VISCOSITY MANNICH BASE CURING AGENTS

(71) Applicants: Dragan Simovic, Hollywood, FL (US); Gordana Simovic, Hollywood, FL (US)

(72) Inventors: Dragan Simovic, Hollywood, FL (US); Gordana Simovic, Hollywood, FL (US)

(21) Appl. No.: 15/179,736

(22) Filed: Jun. 10, 2016

Related U.S. Application Data
(60) Provisional application No. 62/174,283, filed on Jun. 11, 2015.

(51) Int. Cl. C08K 5/17; C08K 11/00; C08K 3/08; C08K 3/34; C08K 3/22; C08K 5/3462; C08K 7/20

(52) U.S. Cl. CPC C08K 5/17; C08K 5/3462; C08K 11/00; C08K 7/20; C08K 3/34; C08K 3/22; C08K 3/08; C08K 2003/2227

(57) ABSTRACT

A Mannich Base curing agent is provided that is prepared by reacting acetone, a phenolic compound and a primary amine. These curing agents are useful as sole curing agents and as co-curing agents for epoxy resin systems. The invention also includes a curable composition having an epoxy resin having at least 1.5 epoxy groups per molecule; and a Mannich Base prepared by reacting (i) a ketone (ii) a phenolic compound and (iii) a primary aliphatic or cycloaliphatic polyamine in which the Mannich Base has a viscosity of less than 500 cP at 25° C.

### TECHNICAL FIELD

This invention relates to Mannich Base curing agents particularly for epoxy resin systems and to new processes for producing Mannich Base curing agents without the use of formaldehyde or higher aldehydes homologues.

### BACKGROUND OF THE INVENTION

There are number of classes of curing agents for epoxy resins. Among these, amines and amine derivatives offer the greatest utility for curing of epoxy resins. Amines are the only available materials that provide potential for curing, both in thin films and larger mass, at room temperature. Aromatic amine curing agents have been in the past used extensively. However, due to toxicity concerns, the use of aromatic amines has been significantly reduced. Current amine-based curing agents are predominantly either aliphatic or cycloaliphatic in nature. The examples are: diethylene triamine, isophorone diamine and rnetaxylene diamine.

Many commercial curing agent formulations are based on these aliphatic and cycloaliphatic arnines which have been altered in some way. The modifications are aimed at either refining performance characteristics, or to improve combilino ratios with epoxy resins, or decrease toxicity of the amine. The most frequently utilized commercially available amines are relatively small molecules with rather large concentrations of nitrogen. Low molecular weight members of the amine family of compounds are sufficiently volatile that the harmful concentrations can accumulate within confined air spaces.

Amines are organic bases and react readily with atmospheric moisture and carbon dioxide forming corresponding amine carbonates. This reaction is effectively blocking or hindering reaction of amine with epoxide. This occurrence is most obviously evident in curing of thin films. Applied coatings of epoxy resin bended with unmodified amines will mostly remain uncured, except if outside heat source is applied. Furthermore, amine carbonate is insoluble in the medium, and will remain on the surface of the coating as a cloudy film, commonly referred in the industry as “bloom,” “blush” or “sweat-out.”

Most commonly, the amines are combined with epoxy resins such that a ratio of amine hydrogen units employed per each epoxide group is approximately 1 to 1. The lower molecular weight ethylene amines have the capability to form closely cross-linked networks when used as epoxy curing agents. However, at ambient temperature, curing rate slows as polymer viscosity increases with increase of molecular weight upon polymerization. As a consequence, the curing process is incomplete, unless accelerators or elevated temperature is applied; due to so-called “vitrification” of the polymer network (un-reacted amine functional groups are “frozen” in space without possibility to reach un-reacted epoxy functionalities). If low molecular weight, highly functional amines are to be useful for ambient temperature cure, they must be modified in some fashion to reduce carbonation and volatility and to improve curing performance.

One model of amine modification leading to reduced carbonation is the production of Mannich Bases. Traditionally, the Mannich base compounds are products based on the reaction of an aldehyde, generally formaldehyde, a phenolic compound and an amine. Examples are shown in U.S. Pat. No's. 3,734,965, 5,569,536 and 5,120,817. Similarly, aldehydes such as butyraldehyde are used to obtain Mannich Base curing agents with relatively lower viscosity of the product (U.S. Pat. No. 5,569,536).

Mannich Bases presented here are products of a phenolic compound, a ketone and an amine. A Mannich Base in combination with liquid epoxy resins provides the following beneficial features:
1. Rapid cure, both at ambient and reduced temperature,
2.Good mechanical strength and hardness properties, and
3. Largely useful chemical resistance characteristics.

When traditional Mannich Bases are synthesized from formaldehyde, aforementioned beneficial curing agent features are intensified with higher levels of formaldehyde utilized. However, such high levels tend to advance product viscosity beyond a useable range. Low viscosity is desirable for most applications involving this class of curing agent. Mannich Bases produced utilizing ketones as a carbonyl “bridge” source between phenolic and amine molecule show much lower viscosities with preserving strong functional benefits versus Mannich Bases made from a formaldehyde process.

### SUMMARY OF THE INVENTION

According to the invention, an epoxy resin formulation is provided including an epoxy resin having at least 1.5 epoxy groups per molecule, and a Mannich base prepared by reacting a ketone (I) a phenolic compound (II) and a primary polyamine (III), as below defined. The composition is useful for adhesives applications, for flooring applications, for encapsulation, and for coatings.

This invention also relates to Mannich Base condensates prepared from the alkyl phenol, ketones and aliphatic or cycloaliphatic polyamines. More particularly, this invention relates to initial Mannich condensates prepared by reacting alkyl phenol with a ketone and a first primary alkylene diamine (polyamine) to provide intermediate alkyl phenol Mannich condensate, which are further reacted with a ketone and a second alkylene diamine (polyamine) as hereafter described to provide the final Mannich condensate.

A family of Mannich Bases may be prepared from the reaction of a phenolic compound, a ketone and aliphatic or cycloaliphatic polyamine. Traditionally utilized aldehydes (formaldehyde, butyraldehyde, and acetaldehyde) are replaced with ketones, such as: acetone, methyl ethyl ketone, methyl isobutyl ketone, and the like. Such produced Mannich Base amine curing agents show superior properties such as low viscosity and better wetting characteristics, while keeping traditionally preferred features, like fast low temperature and thin layer cure with epoxies. Mannich Base amine curing agents obtained using ketones rather than aldehydes may be used as sole curing agents or co-curing agents for epoxy resin systems.

It is an object of the invention to produce Mannich Base curing agents using a synthetic strategy of acetone, or ketones in general, rather than formaldehyde or aldehydes in general, this having advantages including:
1. Raw material toxicity is significantly lower (acetone is considered an exempt solvent in the USA) vs. highly toxic formaldehyde.
2. Lower viscosity of the final liquid Mannich Base curing agent allows for lower levels of highly flammable and toxic organic solvents to be utilized in coating applications such as toluene, xylene, benzene and the like. This is the advantage from an ecological as well as health hazard perspective.
3. Solvent free formulations (“100% solids” claim, “VOC free”) are possible utilizing lower viscosity curing agents with appropriate combinations of other curing agents and epoxy materials.
4. From an economic standpoint, utilizing relatively inexpensive acetone (which is a readily available by-product from phenol production industry) and reduction in cost of needed solvents in final formulations of coatings and adhesives, are further important objects of utilizing this invention.

### DETAILED DESCRIPTION OF THE INVENTION

The present invention relates to Mannich Bases prepared by reacting at least one a ketone compound having formula (I), at least one phenolic compound having formula (II) and at least one polyamine of formula (III). It is anticipated to produce a Mannich Base curing agent having low viscosity, generally less than about 1000 cP at 25° C., preferably less than 500 cP at 25° C., for use with epoxy resins. It has been found that the epoxy resin system of the invention containing a Mannich Base prepared by reacting a ketone (I), a phenolic compound (H) and a primary polyamine (III) has good performance characteristics and very low viscosity, all as defined below.

In general, the molarity ratio of the polyamine to a ketone is within the range of about 1:1 to about 10:1, preferably from about 2:1 to about 4:1. On an equivalents basis, the ratio of a ketone to polyarnine should be less than or equal to one mole of a ketone per equivalent of amine nitrogen. Similarly, the ratio of a ketone to phenolic compound should be more than, or equal to one and no more than two moles of a ketone per equivalent of phenolic compound.

In general, the polyamine and the phenolic compound are placed in a suitable vessel, and mixed thoroughly. A ketone is then added, either continuously over a period of time, or incrementally. Reaction is spontaneous and fairly exothermic. Precautions for temperature control are required. After completion of ketone addition, water that is formed as a by-product is removed by distillation. Chemical reaction during synthesis is understood to involve electrophilic addition of ketone to phenolic compound to form an alkanolated phenol intermediate. Subsequent condensation with amine and elimination of water yields the Mannich reaction product IV.

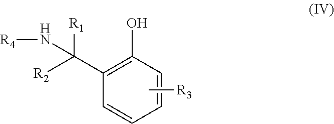

Mannich base products are used either as individual curing agents or as co-curing agents for epoxy resin systems.

The ketone participating in this reaction can be any compound of the general formula (I):

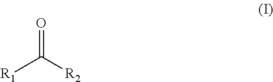

wherein R₁ and R₂ are hydrocarbonyl groups having from 1 to 6 carbon atoms.

The phenolic compound can be any compound which contains at least one hydroxyl group attached to at least one aromatic ring. The aromatic ring(s) may have one or more substituents such as alkyl groups, as long as at least one carbon atom located at the 1, 4 or 6 positions relative to the phenolic hydroxyl bearing carbon atom is un-substituted. Preferably the phenolic compound can be exemplified by the formula:

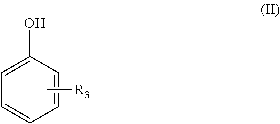

wherein R₃ is a hydrogen or hydrocarbonyl group having from 1 to 20 carbon atoms. R₃ can be linear, branched, cycloaliphatic or aromatic. Examples of suitable phenolic compounds include phenol, nonylphenol, butylphenol, ortho, meta and paracresols, hydroquinone, paraphenylphenol, bisphenol A, bisphenol F, cardanol and dodecylphenol.

The polyamine can be any primary polyamine. Preferably the polyamine can be represented by the formula (III):

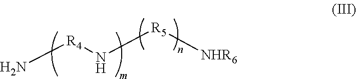

wherein R₄, R₅ are divalent hydrocarbonyl groups, and R₆ is a monovalent hydrocarbonyl group (or a hydrogen atom) preferably having 2 to 12 carbon atoms, and m and n are integers ranging from 0 to 6, with the condition that m and n may not both be simultaneously 0 and ma+n is at least 1. The hydrocarbonyl groups may be branched or linear alkylene groups, cycloaliphatic groups or contain aromatic groups as long as the attached amines are primary aliphatic amines. Examples of the polyamines include aminoethyl piperazine, 2-methylpentane diamine, diethylene triamine, triethylene tetramine, tetraethylene pentamine, isophorone diamine, metaxylylene diamine and 1,2-diaminocyclohexane.

The Mannich Base curing agent is present in an amount effective to cure the epoxy resin. The weight ratio of the epoxy resin to Mannich Base curing agent is typically from about 1:1 to about 6:1, but preferably from about 2:1 to about 3:1.

Accelerators are typically not required, but can be utilized, if preferred to increase the cure rate of the epoxy resin-curing agent system. Various amine-compatible accelerators can be used as long as they are soluble in the Mannich Base curing agent. Examples of useful accelerators include 2,4,6-tris(dimethylaminomethyl)phenol, N,N-Diethylethanolamine, N,N-Dimethylbenzylarnine, Triethanolamine and the like.

The epoxy resin can be any epoxy resin which can be cured by the Mannich Base curing agent. Generally, the epoxy resin can be any curable epoxy resin having a 1,2-epoxy equivalency greater than one and preferably, on the average, more than about 1.5 epoxide groups per molecule. The epoxy resin can be saturated or unsaturated, linear or branched, aliphatic, cycloaliphatic, aromatic or heterocyclic. It may tolerate substituents which do not interfere with the curing reaction. Such substituents can include bromine or phosphate moieties. The epoxy resin may be monomeric, oligomeric or polymeric, liquid or solid. It is preferably liquid at room temperature. Suitable epoxy resins include glycidyl ethers prepared by reacting epichlorohydrin with a compound containing at least one, preferably two or more, phenolic hydroxyl groups carried out under alkaline reaction conditions. Examples of epoxy resins suitable for use in the invention include polyglycidyl ethers of polyhydric phenols, epoxy novolacs, bishpenol A, bisphenol F or similar glycidated polyphenolic resins. It includes glycols or polyglycols, and polyglycidyl esters of polycarboxylic acids.

Examples of suitable polyhydric phenols include: 2,2-bis(4-hydroxyphenyl) propane (bisphenol-A); 1,1-bis(4-hydroxyphenyl) ethane; 1,1-bis(4-hydroxyphenyl) isobutane; bis(2-hydroxy-1-naphthyl)methane and the like. Suitable polyhydric phenols can also be obtained from the reaction of phenol with aldehydes such as formaldehyde (bisphenol-F). Synthetic products of these polyglycidyl ethers of polyhydric phenols with phenolic compounds such as bisphenol-A are also suitable as epoxy resins. Examples are shown in U.S. Pat. Nos. 3,477,990 and 4,734,468. Commercial examples of preferred epoxy resins include EPON® Resins 862, 828, 825 and 1001 available from Shell Chemical Company.

These preferred epoxy resins may also optionally be blended with a glycidyl ether of an aliphatic or aromatic alcohol, Examples include: phenyl glycidyl ether, cresyl glycidyl ether, 1,4-butanediol diglycidyl ether, the glycidyl ester of neodecanoic acid, and the like,

The favored epoxy resin systems of the invention may contain one or more epoxy resins and a curing agent containing the Mannich Base. When used as co-curing agent, the ketone-based Mannich curing agent can be used with another curing agent for epoxy resins. Such curing agents include the reaction products formed through reaction of an excess of a polyamine with a monocarboxylic or polycarboxylic acid, epoxy resin, a monoglycidyl ether of an aliphatic or aromatic alcohol, or the glycidyl ester of a monocarboxylic or polycarboxylic acid. Such modified amines are well known in the art.

A curable epoxy resin formulation can be cured at a temperature within the range of from about −5° C., preferably from about 0° C. to about 150° C., for a time effective to cure the epoxy resin. For standard ambient cure applications the composition is preferably cured at ambient temperature from about 10 C. to about 40° C.

The epoxy resin formulation is useful for adhesives, coatings, flooring, casting and encapsulants.

The curable epoxy resin formulation can be applied by any number of ways including brush, roller, spray, squeegee and the like. It can be poured or injected into a suitable mold and allowed to cure.

For adhesives, the curable epoxy resin formulation will typically be applied to a substrate either neat or in a solvent, at ambient or elevated temperature. Solvent, if any, will be allowed to evaporate and the substrates will be pressed together, followed by cure of the adhesive at ambient or elevated temperatures.

For flooring applications, the curable epoxy resin formulation can be combined with fillers like: sand, glass beads, ground talc or alumina, metallic powders, fillers, pigments, and the like. The material can be applied to a substrate by brushing, troweling squeegeeing or other suitable means.

For coatings applications, the curable epoxy resin formulation can contain various solvents, fillers, flow control agents, pigments and pigments and plasticizers. Application to a substrate can be by brushing, spraying, rolling, squeegeeing, or any other suitable means.

For casting and encapsulation, the curable epoxy resin formulation can likewise contain various fillers, pigments, plasticizers and alike. Application can be by pouring, injection or other means of introduction into a suitable mold.

It has been found that use of a ketone, rather than formaldehyde or paraformaldehyde, results in products exhibiting unexpectedly low viscosity, even though the molecular weight of a ketone is higher than that of formaldehyde. Generally, increasing molecular weight correlates to higher viscosity.

### ILLUSTRATIVE EMBODIMENTS

The following illustrative embodiments describe the process of the invention. The examples are provided for illustrative purposes and are not meant as limiting of the invention.

Acetone of 99% purity was obtained from Sigma-Aldrich. Metaxylylene diamine was obtained from Huntsman Corporation. Triethylene tetramine was obtained from Dow Chemical Company.

Cardanol, Para-tertiary-butylphenol and Nonylphenol were obtained from VWR. DER 331 (a diglycidyl ether of bisphenol A having epoxy equivalent weight of 182-192) was obtained from DOW Chemical Company.

Examples 1 to 6 below demonstrate the low viscosity of the Mannich Base curing agent prepared from a ketone, a phenolic compound and a diarnine. Example 7 illustrates accelerated reaction between the Mannich Base curing agent produced in example 5 and diglycidyl ether of bisphenol A (DER 331)

### EXAMPLE 1

To a 2-liter 3-neck flask equipped with a stirrer, thermocouple, condenser, distillation receiver and addition funnel, were added 272 grams (2 moles) of metaxylylene diamine (“MXDA”) and 220 grams (1 mol) of para-nonylphenol. The flask contents were purged with argon and the temperature had increased spontaneously to 42° Celsius. 139.2 grams (2.4 moles) of acetone was added drop wise to the mixture over 60 minutes while maintaining 54°-56° C. (initially, the temperature reached 62° C.). After an additional 60 minutes at 54°-56° C., the temperature was raised to 150° C. All distillate was collected during this temperature increase. After holding 30 minutes at 150° C., the temperature was raised to 160° C. After 45 minutes, flask contents were cooled and discharged. Yield was 543 grams (95%) of a pale amber liquid having density of 8.34 pounds per gallon and a Brookfield viscosity at 25° C., of 115 cP,

### EXAMPLE 2

Example 1 was repeated, except that of 272 grams (2 moles) of metaxylylene diamine (“MXDA”) were substituted with 292 grams (2 moles) of triethylenetetramine (TETA). 553.5 grams (93.5%) of the product was obtained having density of 8.04 pounds per gallon and a viscosity of 340 cP at 25° C.

### EXAMPLE 3

Example 1 was repeated, except that of 272 grams (2 moles) of metaxylylene diamine (“MXDA”) were substituted with 258 grams (2 moles) of aminoethylpiperazine (AEP). 547 grams (98%) of product was obtained having density of 8.10 pounds per gallon and a viscosity of 450 cP at 25° C.

### EXAMPLE 4

Example 1 was repeated, except that 272 grams (2 moles) of rnetaxylylene diamine (“MXDA”) were substituted with 292 grams (2 moles) of triethylenetetramine (TETA) and 220 grams (1 mol) of nonylphenol was substituted with 298 grams (1 mol) of cardanol, 644 grams (96%) of product was obtained having density of 7.99 pounds per gallon and a viscosity of 130 cP at 25° C.

### EXAMPLE 5

Example 1 was repeated, except that 272 grams (2 moles) of rnetaxylylene diamine (“MXDA”) were substituted with 258 grams (2 moles) of aminoethyipiperazine (AEP) and 220 grams (1 rnol) of nonylphenol was substituted with 298 grams (1 mol) of cardanol, 586 grams (92%) of product was obtained having density of 7.98 pounds per gallon and a viscosity of 120 cP at 25° C.

### EXAMPLE 6

To a 2-liter 3-neck flask equipped with a stirrer, thermocouple, condenser, distillation receiver and addition funnel, were added 136 grams (1 mol) of metaxylylene diamine (“MXDA”) and 220 grams (1 mol) of para-nonylphenol. The flask contents were purged with argon and the temperature had increased spontaneously to 42° Celsius, 86.4 grams (1.2 moles) of methylethylketone was added drop wise to the mixture over 60 minutes while maintaining 54°-56° C. (initially, the temperature reached 60° C.). After an additional 60 minutes at 54°-60° C. the temperature was raised to 150° C. All distillate was collected during this temperature increase. After holding 30 minutes at 150° C., the temperature was raised to 160° C. After 45 minutes, flask contents were cooled and discharged. Yield was 385 grams (97%) of a pale amber liquid having density of 8.30 pounds per gallon and a Brookfield viscosity at 25° C. of 125 cP.

### EXAMPLE 7

To a plastic cup of 250 mL were added 68.8 g of reaction product obtained in Example 5 and 81.2 g of DER 331. Steel spatula was used to thoroughly mix the two materials for 1 minute. Temperature increase was measured and time until the mixture was no longer in liquid state and solid ball was created in the center of the mass. Gel time for this combined mass of 150g was 13 minutes and peak exotherm temperature was measured to be 191° C.

While there has been shown and described above the preferred embodiment of the instant invention it is to be appreciated that the invention may be embodied otherwise than is herein specifically shown and described and that, within said embodiment, certain changes may be made in the form and arrangement of the parts without departing from the underlying ideas or principles of this invention as set forth in the Claims appended herewith.

I claim:

1. A curable composition, comprising:
(a) an epoxy resin having at least 1.5 epoxy groups per molecule; and
(b) a Mannich Base prepared by reacting (i) a ketone (ii) a phenolic compound and (iii) a primary aliphatic or cycloaliphatic polyamine, wherein the Mannich Base has a viscosity of less than 500 cP at 25° C. with proposed structure

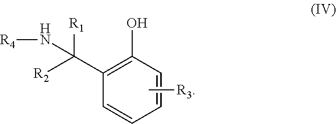

2. The composition of claim 1 wherein the ketone is one of the following 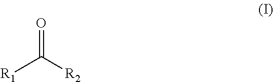
wherein R₁ and R9 are hydrocarbonyl groups having from 1 to 6 carbon atoms.

3. The composition of claim 1 in which said phenolic compound can be represented by the formula: 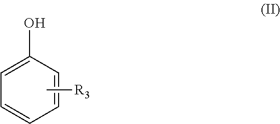
wherein R₃ is hydrocarbonyl group having from 1 to 20 carbon atoms,

4. The composition of claim 2 wherein the polyamine can be represented by the formula 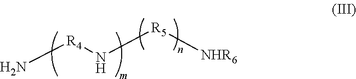
wherein R₄ and R₅ are divalent hydrocarbonyl groups having 2 to 20 carbon atoms, R₆ is hydrogen or monovalent hydrocarbonyl group having 2 to 20 carbon atoms and “m” and “n” are integers ranging from 0 to 5, provided that “m+n” is at least 1.

5. The composition of claim 4 wherein the polyamine is selected from the group consisting essentially of aminoethyl piperazine, diethylene triarnine, triethylene tetramine, tetraethylene pentamine, isophorone diamine, metaxylylene diamine, 1,2-diaminocyclohexane and monoethanolamine.

6. The coniposition of claim 1 wherein the epoxy resin is a polyglycidyl ether of a polyhydric phenol.

7. The composition of claim 1 wherein the ratio of molarity of the epoxy resin to Mannich Base is from about 1:1 to about 6:1.

8. The cured composition of claim 1.

9. An epoxy resin formulation composition of claim 1, in which at least one composition is selected from the group consisting essentially of sand, glass beads, ground talc, ground alumina, metallic powders, fillers, plasticizers and pigments.

10. The composition of claim 7, wherein the ratio of molarity of the epoxy resin to Mannich Base is from about 2:1 to about 3:1.
